(19) United States
(12) Patent Application Publication
(10) Pub. No.: US 2011/0170576 A1
(43) Pub. Date: Jul. 14, 2011

(54) RANGING APPARATUS, POSITIONING APPARATUS, AND METHODS OF RANGING AND POSITIONING THEREFOR

(75) Inventors: Takafumi NAGANO, Tokyo (JP); Takashi Iwamoto, Tokyo (JP)

(73) Assignee: MITSUBISHI ELECTRIC CORPORATION, Chiyoda-ku (JP)

(21) Appl. No.: 12/026,902

(22) Filed: Feb. 6, 2008

(30) Foreign Application Priority Data
Mar. 6, 2007 (JP) 2007-055474

(51) Int. Cl. H04B 1/707

(52) U.S. Cl. 375/147; 375/E01.002

(57) ABSTRACT

A multipath mitigation technology (MMT) can mitigate the influence of multipath when a received signal is composed of a single direct-path wave and a single multipath wave. However, in an actual environment, it is not always true that the number of multipath wave is only one. When a plurality of multipath waves is included in the received signal, the influence of multipath cannot be completely removed. On the contrary, when no multipath wave is included, an error occurs because a single direct-path wave is deemed as a single direct-path wave and a single multipath wave for estimation. In addition, difficulties arise in calculation when maximum likelihood estimation is performed targeting a time-domain signal. A positioning apparatus estimates parameters for a signal model by applying thereto the maximum likelihood estimation in the frequency domain, and estimates the signal model based on an information criterion, so that multipath errors are mitigated.

### BACKGROUND OF THE INVENTION

1. Field of the Invention

The present invention relates to ranging apparatus that measure a range to a receiver based on propagation time-delay of a signal sent from a radio station (transmitter), and to methods therefor. Moreover, the present invention relates to positioning apparatus that locate a position of the receiver, and to methods therefor, using the ranging apparatus and the ranging methods.

2. Description of the Related Art

Positioning utilizing the GPS (Global Positioning System) satellites is used in a wide range of fields. In the center of a city or the like, demand for the positioning is also increasing; however, the influence of multipath has been one of large factors that cause errors in the positioning. Up to this time, in order to reduce multipath errors, a multipath mitigation technology (hereinafter “MMT,” refer to U.S. Pat. No. 6,370,207) and “narrow correlator” (refer to page 120 of “Global Positioning Systems, Inertial Navigation, and Integration,” by Mohinder S. Grewal, Lawrence R. Weill, and Angus P. Andrews, 2001, John Wiley & Sons, Inc.) have been developed.

The MMT is known as a system that can mitigate, in a signal model of a single direct-path wave and a single multipath wave, by performing parameter estimation for the signal model by applying thereto a maximum likelihood estimation method, the influence of multipath whose additional delay is small, which has been conventionally difficult to be dealt with.

### Problems to be Solved by the Invention

In the MMT, when a received signal is composed of a single direct-path wave and a single multipath wave, it is possible to mitigate the influence of multipath. However, in an actual environment, it is not always true that the number of multipath waves is only one. When a plurality of multipath waves is included in the received signal, the influence of multipath cannot be completely removed. On the contrary, when no multipath wave is included, an error occurs because a single direct-path wave is deemed as a single direct-path wave and a single multipath wave for estimation. In addition, difficulties arise in calculation when the maximum likelihood estimation is performed targeting a time-domain signal. To this end, an object of the present invention is to measure a range and to locate a position with a small amount of calculations.

### SUMMARY OF THE INVENTION

### Means for Solving the Problems

A ranging apparatus in the present invention comprises: a signal receiving means for receiving a signal transmitted from a transmitter; a signal estimation means for estimating the signal received by the signal receiving means; a propagation time-delay calculation means for calculating a propagation time-delay of the signal, based on the signal estimated by the signal estimation means; and a ranging means for acquiring, based on the propagation time-delay, a distance between the transmitter and the signal receiving means; wherein the signal estimation means performs in the frequency domain maximum likelihood estimation on parameters for a signal model.

In addition, a positioning apparatus in the present invention is characterized in that, using the ranging apparatus, the signal receiving means receives signals transmitted from at least three transmitters, so as to locate a position of the signal receiving means.

Moreover, a method of measuring a range in the present invention comprises the steps of: receiving by a receiver a signal transmitted from a transmitter; estimating the signal received at the step of receiving a signal; calculating, based on the signal estimated at the step of estimating the signal, a propagation time-delay of the signal; and acquiring, from the propagation time-delay, a distance between the transmitter and the receiver; wherein, in the step of estimating the signal, maximum likelihood estimation is performed on parameters for a signal model, in the frequency domain.

Furthermore, a method of locating a position in the present invention comprises a step of locating a position of a receiver, using the method of measuring a range, wherein the receiver receives signals transmitted from at least three transmitters.

### Effects of the Invention

A ranging apparatus in the present invention comprises: a signal receiving means for receiving a signal transmitted from a transmitter; a signal estimation means for estimating the signal received by the signal receiving means; a propagation time-delay calculation means for calculating a propagation time-delay of the signal, based on the signal estimated by the signal estimation means; and a ranging means for acquiring, based on the propagation time-delay, a distance between the transmitter and the signal receiving means; wherein the signal estimation means performs in the frequency domain maximum likelihood estimation on parameters for a signal model, so that it is possible to measure the range with a small amount of calculations.

In addition, a positioning apparatus in the present invention is characterized in that, using the ranging apparatus, the signal receiving means receives signals transmitted from at least three transmitters, so as to locate a position of the signal receiving means, so that it is possible to locate the position with a small amount of calculations.

Moreover, a method of measuring a range in the present invention comprises the steps of; receiving by a receiver a signal transmitted from a transmitter; estimating the signal received at the step of receiving a signal; calculating, based on the signal estimated at the step of estimating the signal, a propagation time-delay of the signal; and acquiring, from the propagation time-delay, a distance between the transmitter and the receiver; wherein, in the step of estimating the signal, maximum likelihood estimation is performed on parameters for a signal model, in the frequency domain, so that it is possible to measure the range with a small amount of calculations.

Furthermore, a method of locating a position in the present invention comprises a step of locating a position of a receiver, using the method of measuring a range, wherein the receiver receives signals transmitted from at least three transmitters, so that it is possible to locate the position with a small amount of calculations.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 illustrates a flowchart in which ranging and positioning are performed in Embodiment 1 of the present invention;

FIG. 2 is a block diagram showing a configuration of a ranging apparatus and a positioning apparatus in Embodiment 1 of the present invention;

FIG. 3 illustrates a flowchart performing maximum likelihood estimation in Embodiment 1 of the present invention;

FIG. 4 is a diagram showing simulation results of propagation time-delay estimation in Embodiment 1 of the present invention;

FIG. 5 is a diagram showing code-delay estimates of a first arriving wave and a second arriving wave for actual measurement data in Embodiment 1 of the present invention;

FIG. 6 is a diagram showing estimates of the phase difference between a first arriving wave and a second arriving wave for actual measurement data in Embodiment 1 of the present invention; and

FIG. 7 is a diagram showing simulation results of propagation time-delay estimation in Embodiment 2 of the present invention.

### DETAILED DESCRIPTION OF THE PREFERRED EMBODIMENTS

Hereunder, preferred embodiments according to the present invention will be described in detail with reference to the accompanying drawings.

### Embodiment 1

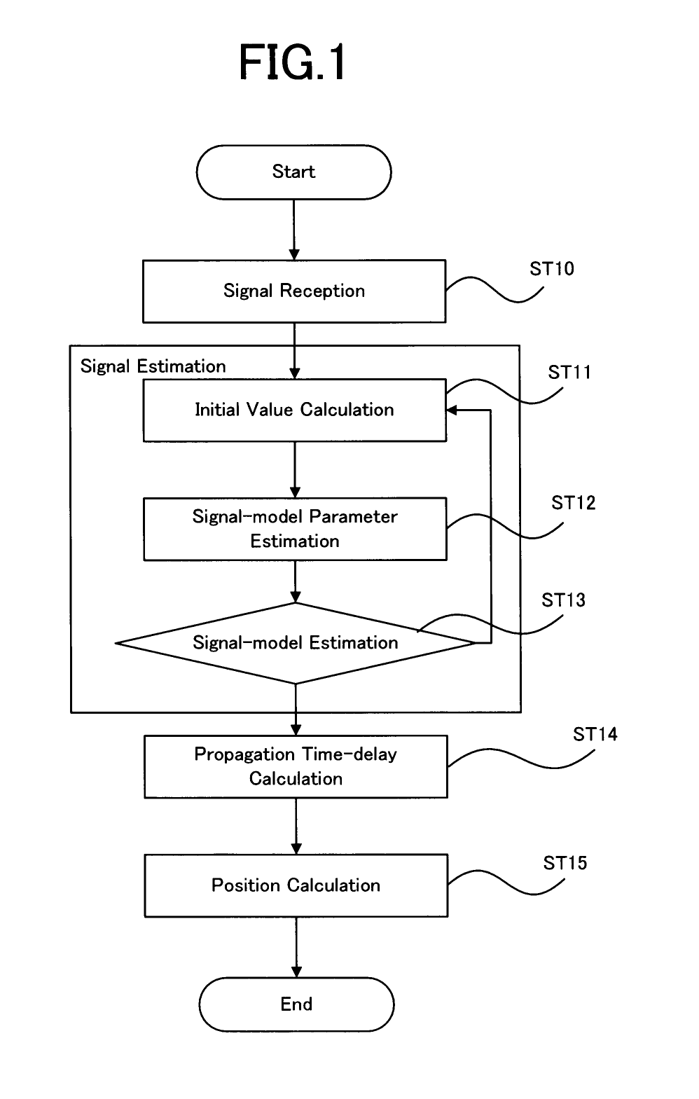

FIG. 1 illustrates a flowchart in which ranging and positioning are performed by a receiver in Embodiment 1 of the present invention. Signals transmitted from a plurality of transmitters (for example, artificial satellites) are received by a signal receiving means (Step ST10); and each of the received signals is estimated by a signal estimation means. Moreover, from the signal having been estimated, a propagation time-delay of the signal is calculated by a propagation time-delay calculation means (Step ST14). From the propagation time-delay having been calculated, a location or position of the receiver is calculated by a position calculation means (Step ST15).

Note that, the signal estimation means is composed of an initial value calculation means, a signal-model parameter estimation means, and a signal-model estimation means. The initial value calculation means calculates initial values of parameters for a signal model (Step ST11); then, the signal-model parameter estimation means estimates parameters for the signal model in the frequency domain (Step ST12). The signal-model estimation means estimates, using an information criterion, a signal model, namely the number of signals (arriving waves) included in the received signal (Step ST12). The signal estimation means outputs, in a signal model having been estimated by the signal-model estimation means, signal-model parameters estimated by the signal-model parameter estimation means to the propagation time-delay calculation means (Step ST13). In addition, until a valid estimation result is obtained for the signal model estimation, Step ST11 and Step ST12 are repeated (Step ST13).

Here, by using a propagation time-delay for each of signals transmitted from a plurality of transmitters, the method of calculating a position of the receiver is generally described; however, by a similar method, it is possible to individually calculate a range between the receiver and a single transmitter. In addition, in a case in which the positioning is performed, at least three artificial satellites acting as transmitters are required. When signals transmitted from four transmitters are received, it is possible to adjust a time offset of an internal clock included in the receiver, so that it becomes possible to perform accurate positioning. On the other hand, when signals transmitted from three transmitters are received, by additionally possessing ground-level data, for example, on the receiver side, it becomes possible to perform accurate positioning.

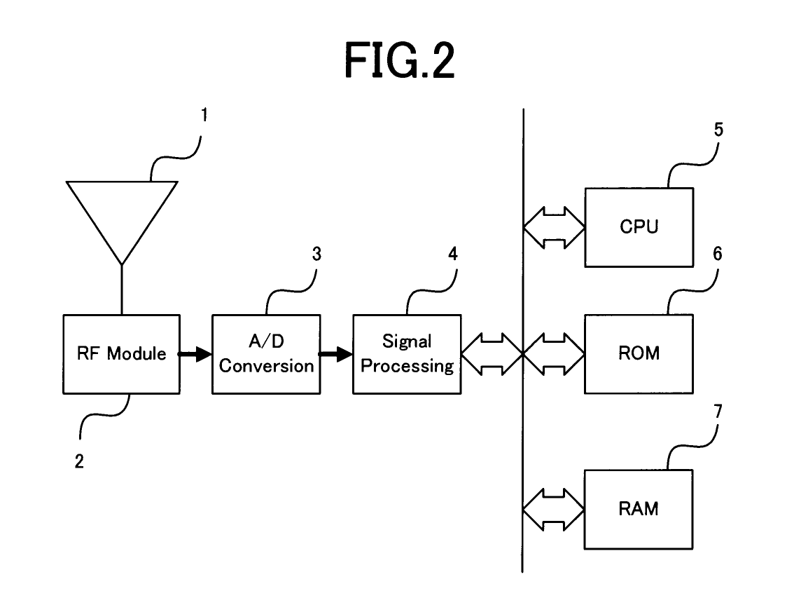

FIG. 2 is a block diagram showing a configuration of a ranging apparatus and a positioning apparatus in Embodiment 1 of the present invention. In Embodiment 1, an embodiment will be explained for positioning using GPS satellites. In the positioning apparatus and the ranging apparatus in the present invention, GPS signals transmitted from a plurality of GPS satellites are received by an antenna 1 of the receiver. The received signal is frequency-converted into an intermediate-frequency signal by an RF (radio frequency) module 2, and is sampled as a digital signal by an A/D (analog-to-digital) converter 3 at predetermined intervals. The sampled signal is converted into a baseband signal by a signal processing unit 4, so that navigation data is extracted therein. The baseband signal and the navigation data are stored into a RAM 7. The signal estimation means including the initial value calculation means, the signal-model parameter estimation means and the signal-model estimation means, the propagation time-delay calculation means, and the position calculation means are stored in a ROM 6 as a program, and executed by a CPU 5.

A baseband signal-model sampled at sampling intervals of T is given in the following equation:

$$q ( j ) = {\sum }_{p = 1}^{P} {α}_{p} {e}^{{iθ}_{p}} m ( j T - {τ}_{p} ) \qquad ( 1 )$$

Here, m(t) is a function of time t, and denotes the C/A-code which is band-limited in accordance with a signal's bandwidth, and a parameter “P” denotes the number of arriving signals through multiple paths. In addition, the amplitude of arriving signals each is denoted as αₚ its initial phase, as θₚ, and the amount of its code delay, as τₚ. The term eⁱ^{^{θ}}^{p} denotes the complex coefficient corresponding to the phase shift of a carrier wave of each arriving signal, and “j” is an index (j-th in order) at the time of sampling. Moreover, let

### α=(α₁, . . . , α_{P})^{T},

### θ=(θ₁, . . . , θ_{P})^{T}, and

### τ=(τ₁, . . . , τ_{P})^{T}.

In addition, “i” is the imaginary unit. In order to ease calculation, the next equation that is equivalent thereto is practically used.

$$q ( j ) = {\sum }_{p = 1}^{P} ( {a}_{p} + i {b}_{p} ) m ( j T - {τ}_{p} ) \qquad ( 2 )$$

Namely, a variable transformation is performed, so that αₚ eⁱ^{^{θ}}^{p}=aₚ+i bₚ. Hereinafter, let
a=(a₁, . . . , a_{P})^{T}, and
b=(b₁, . . . , b_{P})^{T}.

When Equation (2) is discrete Fourier transformed, the next equation is obtained,

$$Q ( ω ) = {\sum }_{p = 1}^{P} ( {a}_{p} - i {b}_{p} ) M ( ω ) {e}^{- {iωτ}_{p}} \qquad ( 3 )$$

where M(ω) is given by the discrete Fourier transform of m(jT).

Let the received baseband signal as r(j), and its discrete Fourier transform as R(ω).

Because the received baseband signal includes noise, let presume r(j)=q(j)+n(j), where n(j) is a complex white noise.

In maximum likelihood estimation targeting a time-domain signal, are obtained parameters a, b, and τ that minimize the next equation (the value Λ).

$$⋀ = {\sum }_{j} {\vert r ( j ) - q ( j ) \vert}^{2} \qquad ( 4 )$$

Here, the maximum likelihood estimation is an estimation method in which, based on observed data in possession, likelihood is presumed as a probability by which a parameter value can be obtained (namely, by presuming the likelihood as a function of unknown parameters); then, the parameter value is searched for by which the likelihood is maximized. Here, by letting r(j)−q(j) as the complex white noise and its occurrence probability as the likelihood, signal-model parameters a, b, and r are estimated for the received signals.

However, in Equation (4), obtaining the amount of code delay τₚ as a value that is not kT(“k” is an integer) results in demand for a large amount of calculations in calculating m(jT−τₚ). In addition, when minimization of Equation (4) is performed by letting τₚ be kT, a calculation error occurs; moreover, when an attempt is made for searching for combinations of τₚ of arriving signals each, according to increase in the number of arriving signals P, explosive increase in the amount of calculations may arise. Even when, by applying a process to round τₚ to kT, a nonlinear minimization technique is intended to be used, there may possibly cause calculation instability.

To this end, in the signal-model parameter estimation means in the present invention, in order to solve the problems described above, estimation of the signal-model parameters for the received signals is performed by the maximum likelihood estimation in the frequency domain. Namely, the next equation is minimized.

$${⋀}^{′} = {\sum }_{ω} {\vert R ( ω ) - Q ( ω ) \vert}^{2} \qquad ( 5 )$$

Here, giving N to the number of samples, NΛ=Λ′ holds.
By expanding Equation (5), the next equation is given,

$${⋀}^{′} = {\sum }_{ω} {\vert R ( ω ) \vert}^{2} - 2 {\sum }_{ω} Re [ R ( ω ) {M}^{*} ( ω ) {\sum }_{p = 1}^{P} ( {a}_{p} - i {b}_{p} ) {e}^{{iωτ}_{p}} ] + {\sum }_{p = 1}^{P} ( {a}_{p}^{2} + {b}_{p}^{2} ) {\sum }_{ω} {\vert M ( ω ) \vert}^{2} \qquad ( 6 )$$

where Re [•] denotes the real part of “•,” and M*(ω) denotes a conjugate complex number of M(ω).

In order to minimize Equation (6), the parameters a, b, and τ are obtained so as to satisfy Equation (7), Equation (8) and Equation (9).

$$\begin{matrix}\frac{\partial {⋀}^{′}}{\partial {a}_{k}} = 0 & ( 7 ) \\ \frac{\partial {⋀}^{′}}{\partial {b}_{k}} = 0 & ( 8 ) \\ \frac{\partial {⋀}^{′}}{\partial {τ}_{k}} = 0 & ( 9 )\end{matrix}$$

Note that, in Equation (7) through Equation (9), k has values from 1 through P.

From Equation (7), Equation (8) and Equation (9), Equation (10), Equation (11) and Equation (12) are derived, respectively,

$$\begin{matrix}{a}_{k} {\sum }_{ω} {\vert M ( ω ) \vert}^{2} + {\sum }_{ω} {\vert M ( ω ) \vert}^{2} {\sum }_{p \neq k} ( {a}_{p} cos ( ω ( {τ}_{p} - {τ}_{k} ) ) + {b}_{p} sin ( ω ( {τ}_{p} - {τ}_{k} ) ) ) = Re [ {\sum }_{ω} R ( ω ) {M}^{*} ( ω ) {e}^{{iωτ}_{k}} ] & ( 10 ) \\ {b}_{k} {\sum }_{ω} {\vert M ( ω ) \vert}^{2} + {\sum }_{ω} {\vert M ( ω ) \vert}^{2} {\sum }_{p \neq k} ( {a}_{p} sin ( ω ( {τ}_{p} - {τ}_{k} ) ) - {b}_{p} cos ( ω ( {τ}_{p} - {τ}_{k} ) ) ) = Im [ {\sum }_{ω} R ( ω ) {M}^{*} ( ω ) {e}^{{iωτ}_{k}} ] & ( 11 ) \\ {\sum }_{ω} Im [ R ( ω ) {M}^{*} ( ω ) {ωe}^{{iωτ}_{k}} ( {a}_{k} - i {b}_{k} ) ] - {\sum }_{ω} {\vert M ( ω ) \vert}^{2} Im [ ( {a}_{k} - i {b}_{k} ) ω {\sum }_{p \neq k} ( {a}_{p} + i {b}_{p} ) {e}^{- iω ( {τ}_{p} - {τ}_{k} )} ] = 0 & ( 12 )\end{matrix}$$

where Im [•] denotes the imaginary part of “•”

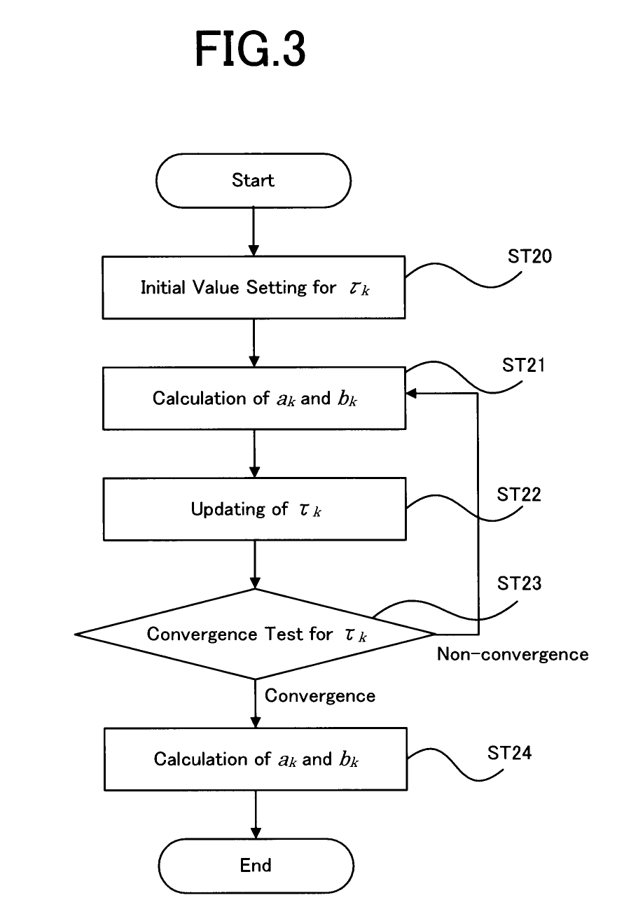

Because Equation (10) and Equation (11) are given as linear equations with respect to aₖ and bₖ, when the value of τ is determined, a and b can be calculated by solving the simultaneous linear equations. For this reason, in the present invention, as shown by the flowchart in FIG. 3, the maximum likelihood estimation is performed for the signal-model parameters.

First, initial values for τₖ (k=1, . . . , P) each are set (Step ST20). Next, by solving the simultaneous linear equations, aₖ and bₖ (k=1, . . . , P) are calculated (Step ST21). Updating of τₖ is performed (Step ST22). A convergence test is conducted as to whether or not the updated τₖ has converged (Step ST23). Step ST21 and Step ST22 are repeated until τₖ converges. When τₖ has converged, aₖ and bₖ are calculated (Step ST24).

In updating τ, values of a and b are regarded as constants, and a method similar to the Newton's method is used.

More specifically, first, let Equation (12) be expressed as fₖ(τ). By partially differentiating fₖ(τ) with respect to τₖ and τₗ, the following equations are derived, respectively (subscripts k and l have values from 1 through P):

$$\begin{matrix}\frac{\partial {f}_{k} ( τ )}{\partial {τ}_{k}} = {\sum }_{ω} Re [ R ( ω ) {M}^{*} ( ω ) {ω}^{2} {e}^{{iωτ}_{k}} ( {a}_{k} - i {b}_{k} ) ] - {\sum }_{ω} {\vert M ( ω ) \vert}^{2} Re [ ( {a}_{k} - i {b}_{k} ) {ω}^{2} {\sum }_{p \neq k} ( {a}_{p} + i {b}_{p} ) {e}^{- iω ( {τ}_{p} - {τ}_{k} )} ] & ( 13 ) \\ \frac{\partial {f}_{k} ( τ )}{\partial {τ}_{l}} = {\sum }_{ω} {\vert M ( ω ) \vert}^{2} Re [ ( {a}_{k} - i {b}_{k} ) {ω}^{2} ( {a}_{l} + i {b}_{l} ) {e}^{- iω ( {τ}_{l} - {τ}_{k} )} ] & ( 14 )\end{matrix}$$

By letting f(τ)=(f₁(τ), . . . , f_{P}(τ))^{T}, its Jacobian matrix is given in the next equation:

$$J ( τ ) = ( \begin{matrix}\frac{\partial {f}_{1} ( τ )}{\partial {τ}_{1}} & … & \frac{\partial {f}_{1} ( τ )}{\partial {τ}_{P}} \\ ⋮ & ⋱ & ⋮ \\ \frac{\partial {f}_{P} ( τ )}{\partial {τ}_{1}} & … & \frac{\partial {f}_{P} ( τ )}{\partial {τ}_{P}}\end{matrix} ) \qquad ( 15 )$$

When updated values of τ are given by τ^{(new)}, τ^{(new)} can be calculated by the next equation (Step ST22):

τ^{(new)}=τ−J(τ)⁻¹f(τ) (16)

When quantitative changes for all τₖ become no more than a predetermined threshold value, it is possible to determine τ has converged (Step ST23).

Next, a method of calculating initial values of τ in the initial value calculation means will be explained. When “P” is one (P=1), the amounts of code delays calculated by a correlator used in a usual GPS receiver can be used. When “P” is larger than one (P>1), the amounts of code delays τ₁, . . . , τ_{P-1} each of which has been calculated when “P” is “P−1” are used. First, each of τ₁, . . . , τ_{P-1} is rounded to a sampling time jT. When a plurality of τₚ is rounded to the same sampling time, an arrangement is made so that the following sampling times will be used; thereby, the arrangement is made so that τₚ≠τₚ₊₁ for all τₚ. Next, each of τ₁, . . . , τ_{P-1} is regarded as a constant; sampling times jT that differ from those for τ₁, . . . , τ_{P-1} are searched for τ_{P} that minimize the value of Equation (6). Thereby, using a correlation function between r(j) and m(jT), and an auto-correlation function of m(jT), Equation (6) can be evaluated at high speed; therefore, initial values of the amounts of code delays can be calculated at high speed. In addition, without getting into a local solution, the maximum likelihood estimation of signal-model parameters can be executed at high speed. In the initial value calculation method, The received baseband signal r(j) and the C/A-code m(jT), which are interpolated to a higher sampling rate, may be used.

By adopting the structure of the initial value calculation means and the signal-model parameter estimation means as described above, when a plurality of signals (arriving waves) is included in the received signal, and the number of arriving waves is supposed to be “n,” it is possible to use an estimation result in the case of “n−1” waves. In addition, when the number of arriving signals is supposed to be “n” waves, in a case in which an estimation result of “n−1” waves is used, initial values of arriving times of signals (arriving waves) each can be calculated as discrete time-points.

The signal-model estimation means will be explained. The signal-model estimation means in the present invention estimates, using an information criterion, a signal model, namely the number of signals (arriving waves). Note that, the information criterion is a criterion for predicting a distribution of future values of a model; the criterion is used as a technique that determines a degree of freedom of model's parameters in order to maximize entropy with respect to a sample distribution of a true distribution (or to obtain a maximum amount of information).

Here, the Bayesian information criterion (hereinafter referred to as “BIC”) is used for explanation. In the BIC, a model that minimizes the next equation is regarded as a “good model,”

BIC=−2 log(Θ)+s log(N) (17)

where “Θ” is maximum likelihood, “N” is the number of samples, and “s” is the number of independent variables.

In the model in which the number of signals is “P” in Equation (1), the next equation can be derived from Equation (17),

BIC(P)=2N(1+log(πσ²))+3P log(N) (18)

where “σ” is a standard deviation of the residuals which is calculated by dividing a minimized value of Equation (5) by the square of N and by obtaining the square root thereof. The first term on the right-hand side of Equation (18) is calculated in a manner in which, by using “σ” as a standard deviation of the complex white noise, an occurrence probability of the complex white noise is calculated, and the calculated value is given as the maximum likelihood “Θ”. The second term on the right-hand side of Equation (18) is derived because, in the signal model of Equation (1), three independent variables αₖ, θₖ and τₖ are included corresponding to a single wave of the signal.

The signal-model estimation means sequentially repeats a process by the initial value calculation means and a process by the signal-model parameter estimation means starting from P=1; then, the value of P that satisfies BIC (P)<BIC (P+1) is set as the number of signals (i.e., the signal model) included in the received baseband signal r(j).

By providing the signal-model estimation means that estimates, using the information criterion, the number of signals (arriving waves) included in the received signal, the signal-model parameters are estimated by a signal model having an appropriate number of signals, so that it is possible to accurately estimate the signal-model parameters.

The propagation time-delay calculation means calculates a propagation time-delay of a direct-path wave in the signal model estimated by the signal estimation means, using the signal-model parameters estimated by the signal-model parameter estimation means, and the navigation data stored in the RAM 7. Here, in the signal model having been estimated, the propagation time-delay is calculated from the estimated signal-model parameters presuming that either a first arriving signal or a first arriving signal whose signal strength exceeds a predetermined threshold value is the direct-path wave.

The position calculation means calculates a receiver's position, in a similar manner to a usual GPS receiver, by using a propagation time-delay of the signals received from a plurality of GPS satellites, and the navigation data stored in the RAM 7.

As described above, the apparatus includes: a signal receiving means for receiving a signal transmitted from a transmitter; a signal estimation means for estimating the signal received by the signal receiving means; a propagation time-delay calculation means for calculating a propagation time-delay of the signal, based on the signal estimated by the signal estimation means; and a position calculation means for calculating, based on the propagation time-delay calculated by the propagation time-delay calculation means, a position of a receiver; thus, the signal estimation means performs, by using a initial value calculation means that calculates initial values of parameters for a signal model and the initial values calculated by the initial value calculation means, in a signal-model parameter estimation means that estimates parameters for the signal model in the frequency domain, the maximum likelihood estimation of the signal-model parameters for the received signal in the frequency domain, so that it is possible to estimate with a small amount of calculations the signal-model parameters from the received signal that includes a plurality of multipath waves.

In addition, in the signal-model parameter estimation means, the maximum likelihood estimation of the signal-model parameters is performed for the received signal by using a result of estimating the received signal as a signal including multipath waves being less by one wave than the multipath waves, in the frequency domain. Moreover, in the initial value calculation means, using a result of estimating the received signal as a the signal including multipath waves being less by one wave than the multipath waves, initial values of arriving times of signals (arriving waves) each included in the received signal are calculated as discrete time-points, so that it is possible to stably estimate the signal-model parameters for the received signal with a small amount of calculations.

Moreover, in the signal-model estimation means, using an information criterion, a signal model, namely the number of signals (arriving waves) included in the received signal is estimated. In addition, in the signal model having been estimated, by presuming a first arriving signal as a direct-path wave based on the estimated signal-model parameters, it is possible to calculate a propagation time-delay of the direct-path wave. Consequently, by using the signal-model parameters having been estimated in the signal model with an appropriate number of signals, it is possible to accurately calculate the propagation time-delay.

In addition, in the signal model having been estimated, a propagation time-delay is calculated based on the estimated signal-model parameters, by presuming as a direct-path wave a first arriving signal whose signal strength exceeds a predetermined threshold value. On this account, even when such a signal is included that has been erroneously estimated as the signal arriving earlier than the direct-path wave, it is possible to accurately calculate a propagation time-delay of the direct-path wave.

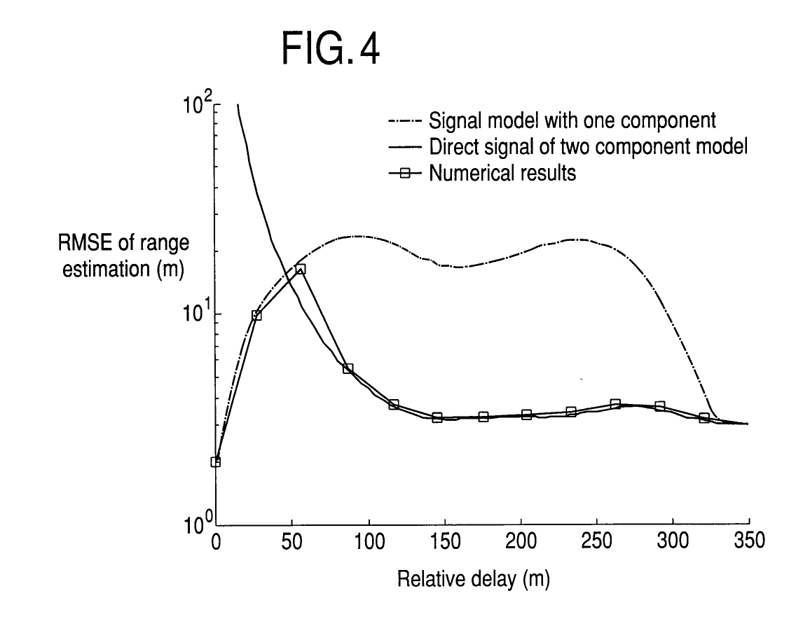

FIG. 4 shows numerical simulation results of propagation time-delay estimation of the direct-path wave in Embodiment 1 of the present invention. In the signal, a single direct-path wave of signal strength −129 dBm and a single multipath wave of signal strength −135 dBm are included. The bandwidth of the signal is 4.092 MHz, and the relative phase difference between the direct-path wave and the multipath wave is 0°. The horizontal axis of the figure indicates relative delay of the multipath wave with respect to the direct-path wave; the vertical axis indicates “estimation error” in the root-mean-square error (hereinafter referred to as an “RMSE”) that is a root-mean-square value of errors. Simulation results according to the present invention are indicated by square markers. In the figure, there also shown are lower bounds of estimation error calculated based on the Cramer-Rao lower bound that is a lower bound of variance of an unbiased estimator. That is, in a case in which estimation is performed presuming a signal as composed of two waves (arriving waves as components), the lower bound of the estimation error is indicated by the solid line (without the square and dot markers); in a case in which estimation is performed presuming a signal of originally two waves as a single wave, the lower bound of the estimation error is indicated by alternate long and short dashed lines. It can be understood that the result according to the present invention has approximately achieved the lower bounds of estimation error.

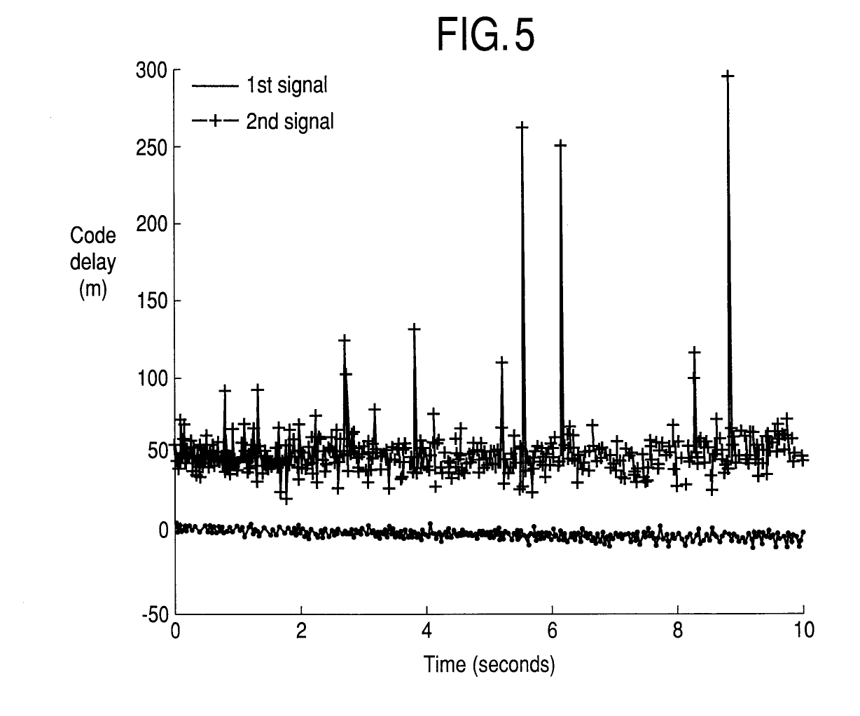

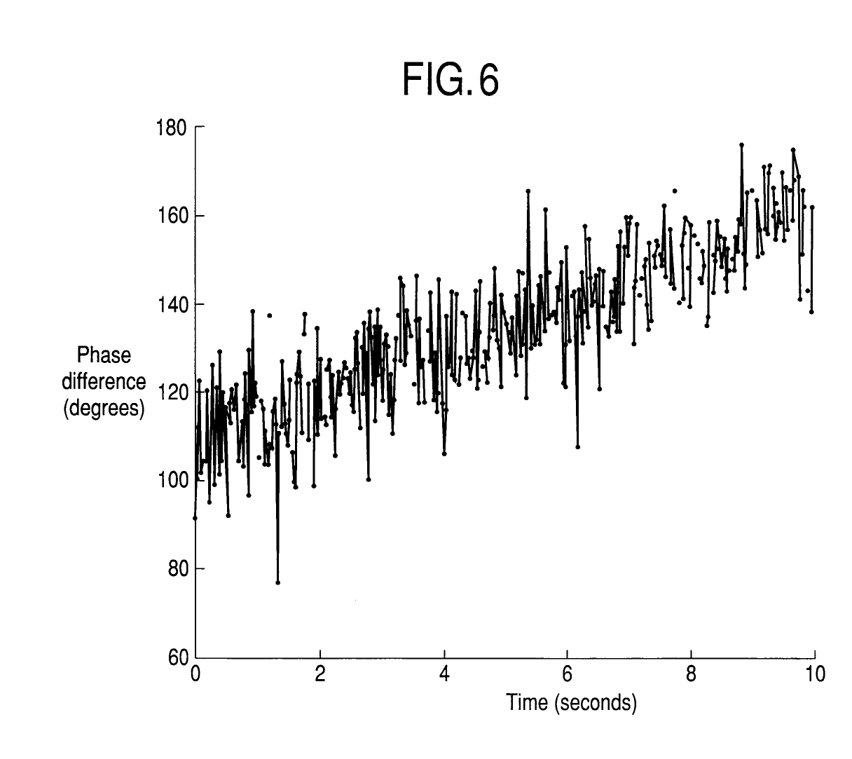

Next, a graph of code-delay estimates of a first arriving wave (1st signal) and a second arriving wave (2nd signal) for actual measurement data in Embodiment 1 of the present invention is shown in FIG. 5. In addition, a graph of estimates of the phase difference between a first arriving wave and a second arriving wave is shown in FIG. 6. Both the horizontal axes of FIG. 5 and FIG. 6 are scaled in time; the vertical axis of FIG. 5 indicates the amounts of code delay, and the vertical axis of FIG. 6 indicates the phase difference. In FIG. 5, a first-order component in a code-delay estimates of the first arriving wave is cancelled out, and a mean amount of code delay of the first arriving wave is set to be zero. From FIG. 5, it can be understood that a multipath wave with some 50 m additional delay is recognizable, which indicates a reasonable value under the measurement conditions. In addition, from FIG. 6, it can be also recognized that the amounts of delay are gradually drifting with the movement of a satellite.

### Embodiment 2

Embodiment 2 differs, in comparison to Embodiment 1, in a signal-model estimation means and a propagation time-delay calculation means. Other constituent items are equivalent or similar to those in Embodiment 1. The same reference numerals and symbols designate the same items as or items corresponding to those described in Embodiment 1; thus their explanation is omitted.

When signal strength of a direct-path wave is presumed substantially larger than that of multipath waves each, the signal-model estimation means selects a signal model with a predetermined number of signals, and the propagation time-delay calculation means regards as the direct-path wave, a signal whose signal strength is the largest among the signals estimated by the signal-model parameter estimation means in the signal model, and calculates a propagation time-delay for the signal. According to this arrangement, it is further possible to accurately calculate a position of a receiver. Embodiment 2 is suitable in use even when the signal bandwidth is narrow and the number of signals which can be estimated is small. In particular, when signal strength of a direct-path wave is substantially larger than that of multipath waves each, Embodiment 2 is effective in use when multipath waves are included where a relative time-delay is small with respect to the direct-path wave.

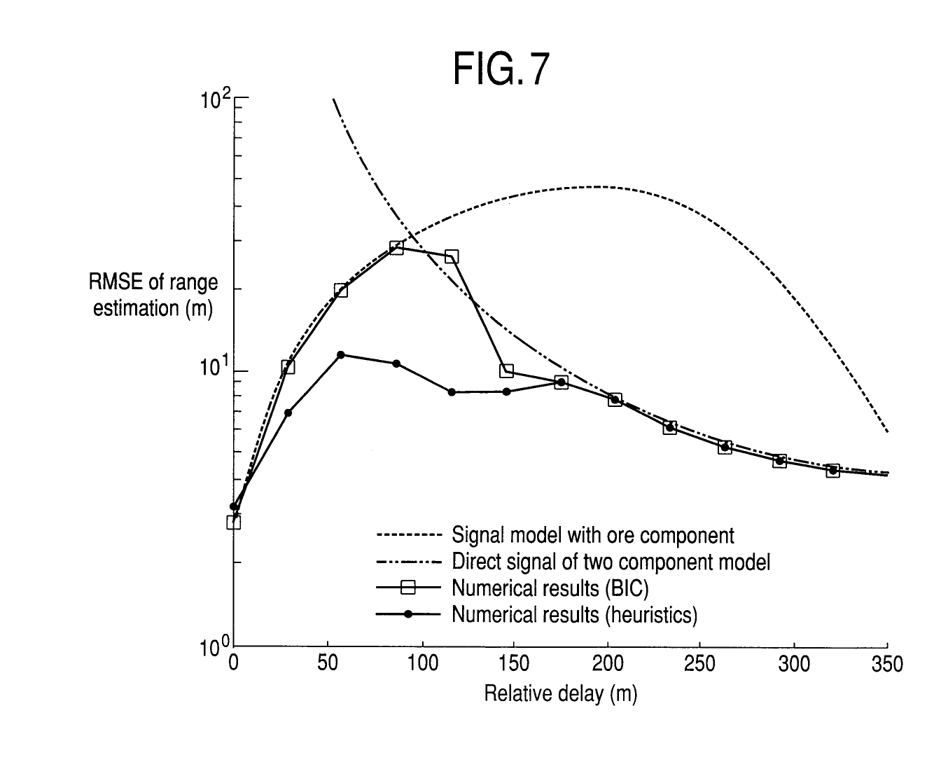

Numerical simulation results of a propagation time-delay estimation of the direct-path wave in Embodiment 2 of the present invention are shown in FIG. 7. In the signal, a single direct-path wave of signal strength −129 dBm and a single multipath wave of signal strength −135 dBm are included. The bandwidth of the signal is 2.046 MHz, and the relative phase difference between the direct-path wave and the multipath wave is 0°. The horizontal axis of the figure indicates relative delay of the multipath wave with respect to the direct-path wave; the vertical axis indicates estimation error in the RMSE. Simulation results according to Embodiment 1 are indicated by square markers; and simulation (heuristics) results according to Embodiment 2 are indicated by dot markers. In the figure, there also shown are lower bounds of estimation error calculated based on the Cramer-Rao lower bound that is a lower bound of variance of an unbiased estimator. That is, in a case in which a signal composed of two waves (components) is estimated, the lower bound of the estimation error is indicated by the solid line (without the square and dot markers); in a case in which a signal of originally two waves is estimated as a single wave, the lower bound of the estimation error is indicated by alternate long and short dashed lines. It can be understood that the result of Embodiment 2 has smaller estimation errors than the result in Embodiment 1; thus, the former is superior to the latter. Note that, the result of Embodiment 2 is superior to the lower bounds of estimation error calculated based on the Cramer-Rao lower bound that is a lower bound of variance of an unbiased estimator; this is because the estimator in Embodiment 2 is not the unbiased estimator (i.e., the estimator has a bias error).

While the present invention has been shown and described in detail, the foregoing description is in all aspects illustrative and not restrictive. It is therefore understood that numerous modifications and variations can be realized without departing from the scope of the invention.

What is claimed is:

1. A ranging apparatus, comprising:
a signal receiving means for receiving a signal transmitted from a transmitter;
a signal estimation means for estimating the signal received by said signal receiving means;
a propagation time-delay calculation means for calculating a propagation time-delay of the signal, based on the signal estimated by said signal estimation means; and
a ranging means for acquiring, based on the propagation time-delay, a distance between the transmitter and said signal receiving means; wherein
said signal estimation means performs in the frequency domain maximum likelihood estimation on parameters for a signal model.

2. The ranging apparatus as set forth in claim 1, wherein the signal estimation means uses, when estimating the received signal as a signal including a plurality of multipath waves, a result of estimating the received signal as a signal including multipath waves being less by one wave than the plurality of multipath waves.

3. The ranging apparatus as set forth in claim 2, wherein the signal estimation means calculates, when estimating the received signal as a signal including a plurality of multipath waves, initial values of arriving times of signals each included in the received signal as discrete time-points.

4. The ranging apparatus as set forth in claim 1, wherein the signal estimation means estimates, using an information criterion, the number of signals included in the received signal.

5. The ranging apparatus as set forth in claim 4, wherein the signal estimation means calculates a propagation time-delay presuming a first arriving signal as a direct-path wave.

6. The ranging apparatus as set forth in claim 4, wherein the signal estimation means calculates a propagation time-delay, presuming as a direct-path wave a first arriving signal whose signal strength exceeds a predetermined threshold value.

7. The ranging apparatus as set forth in claim 1, wherein when signal strength of a direct-path wave is presumed substantially larger than that of multipath waves each, the signal estimation means calculates a propagation time-delay, presuming that the number of signals included in the received signal is regarded as a predetermined number, and a signal whose signal strength is the largest among the signals is regarded as the direct-path wave.

8. A positioning apparatus, wherein using the ranging apparatus as set forth in any one of claims 1 thorough 7, the signal receiving means receives signals transmitted from at least three transmitters, so as to locate a position of said signal receiving means.

9. A method of measuring a range, comprising the steps of:
receiving by a receiver a signal transmitted from a transmitter;
estimating the signal received at the step of receiving a signal;
calculating, based on the signal estimated at the step of estimating the signal, a propagation time-delay of the signal; and
acquiring, from the propagation time-delay, a distance between the transmitter and the receiver; wherein
in the step of estimating the signal, maximum likelihood estimation is performed on parameters for a signal model, in the frequency domain.

10. A method of locating a position, comprising
a step of locating a position of a receiver, using the method of measuring a range as set forth in claim 9, wherein
the receiver receives signals transmitted from at least three transmitters.
